(19) United States
(12) Patent Application Publication
(10) Pub. No.: US 2007/0073029 A1
(43) Pub. Date: Mar. 29, 2007

(54) Fusible catalysts and polyurethane products made therefrom

(76) Inventors: Francois M. Casati, Pfaffikon (CH); Hanno R. Van Der Wal, Hoek (NL); William J. Harris, Lake Jackson, TX (US); Jerry E. White, Lake Jackson, TX (US); Ray E. Drumright, Midland, MI (US); Robert J. Weber, Stockton, NJ (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/560,342

(22) PCT Filed: Jun. 10, 2004
(86) PCT No.: PCT/US04/18661

§ 371 Date: Dec. 1, 2006

Related U.S. Application Data
(60) Provisional application No. 60/478,602, filed on Jun. 13, 2003.

(51) Int. Cl. C08G 18/00

(52) U.S. Cl. 528/44; 521/172

(57) ABSTRACT

The present invention pertains to fusible catalysts, to processes for their manufactures and to their use in the production of low emission Polyurethane products.

The present invention pertains to fusible catalysts, to processes for their manufacture and to their use in the production of low emission polyurethane products.

Polyether polyols based on the polymerization of alkylene oxides, and/or polyester polyols, are the major components of a polyurethane system together with isocyanates. Polyols can also be filled polyols, such as SAN (Styrene/Acrylonitrile), PIPA (polyisocyanate polyaddition) or PHD (polyurea) polyols, as described in “Polyurethane Handbook”, by G. Oertel, Hanser publisher. These systems generally contain additional components such as cross-linkers, chain extenders, surfactants, cell regulators, stabilizers, antioxidants, flame retardant additives, eventually fillers, and typically catalysts such as tertiary amines and/or organometallic salts.

Organometallic catalysts, such as lead or mercury salts, can raise environmental issues due to leaching upon aging of the polyurethane products. Others catalysts, such as tin salts, are often detrimental to polyurethane aging.

The commonly used tertiary amine catalysts, can also give rise to undesirable effects, particularly in flexible, semi-rigid and rigid foam applications. Freshly prepared foams using these catalysts often exhibit the typical odor of the amines and are associated with fogging (emission of volatile products).

The presence, or formation, of even traces of tertiary amine catalyst vapors in polyurethane products having vinyl films or polycarbonate sheets exposed thereto can be disadvantageous. Specifically, the tertiary amine catalysts present in polyurethane foams have been linked to the staining of the vinyl film and degradation of polycarbonate sheets. This PVC staining and polycarbonate decomposition problems are especially prevalent in environments wherein elevated temperatures exist for long periods of time, such as can occur in automobile interiors.

Various solutions to the above disadvantages have been proposed. One is the use of amine catalysts which contain a hydrogen isocyanate reactive group, that is a hydroxyl or a primary and/or a secondary amine. Such a compound is disclosed in EP 747,407. other types of reactive monol catalysts are described in U.S. Pat. Nos. 4,122,038, 4,368,278 and 4,510,269. Since these compounds are monofunctional, these reactive amines act as chain stoppers and have a detrimental effect-on the polymer build up and affect polyurethane product physical characteristics. Other types of reactive amine catalysts are disclosed in U.S. Pat. No. 3,448,065, in EP 677,540 and in EP 1,109,847. A reported advantage of the catalyst compositions is their incorporation into the polyurethane product. However those catalysts have to be used at high levels in the polyurethane formulation to compensate for their lack of mobility during the reactions.

Various other means have been proposed for incorporating a reactive amine into a polyol. Modification of conventional polyols by partial amination has been disclosed in U.S. Pat. 3,838,076. Pre-polymerization of reactive amine catalysts with a polyisocyanate and a polyol is reported in PCT WO 94/02525. Use of specific amine-initiated polyols is proposed in EP 539,819, in U.S. Pat. No. 5,672,636 and in WO 01/58,976. While these approaches can reduce the amount of amine catalyst required in the system, there are disadvantages associated with each process.

Modifications of polyether polyols with epoxy resin-diamine or epoxy resin amino-alcohol adducts are described in U.S. Pat. Nos. 4,518,720, 4,535,133 and in U.S. Pat. No. 4,609,685. These modifications are reported to improve foam properties. No mention is made of getting an autocatalytic effect or a reduction of catalysts when using these modified polyols. Polyepoxides containing at least one tertiary nitrogen are disclosed in U.S. Pat. No. 4,775,558 and are reported to improve thermal stability of the resulting polyurethane products.

Other epoxy based catalysts are quaternary amine based catalyst compositions as described in U.S. Pat. Nos. 3,010,963, 4,404,120 and 4,040,992. These catalysts are effective for isocyanate trimerization, an undesirable reaction in flexible foams, since it gives softer foam and poor aging characteristics.

Solid epoxy compositions for powder coating are described in EP 1,302,517. These are thermoset resins which polymerize upon heating and under the effect of amine catalysis.

Use of polyesters made from acids and polyoxyalkylene-alkanolamine is claimed in WO 1999/62980. These polyester polyols show a catalytic effect but their production requires two steps, first alkdxylation of the alkanolamine, then esterification reaction with an acid. The final products are liquid.

Despite the advances made in finding alternatives to conventional polyurethane promoting catalysts, there continues to be a need to eliminate or reduce the amount of fugitive and/or reactive amine catalysts and/or organometallic salts in producing polyurethane products.

It is an object of the present invention to produce polyurethane products based on catalysts which are solid at room temperature, have a melting point between 35 and 130° C. and, once melted are able to replace or reduce the use of conventional, fugitive or reactive tertiary amine catalysts.

It is another objective of the present invention to produce polyurethane products containing a reduced level of organometallic catalyst or to produce such products in the absence of organometallic catalysts. With the reduction of the amount of amine and/or organometallic catalysts needed or elimination of such catalysts, the disadvantages associated with such catalysts as given above can be minimized or avoided.

It is another object of the invention to have a process to adjust reactivity, such as foaming and/or gelation rates, and processing of a polyurethane system, by using catalysts which are solid at room temperature, hence inactive, and which, once melted, become catalytically active.

It is a further object of the present invention to provide fusible polyurethane catalysts so that the industrial manufacturing process of the polyurethane product using these fusible catalysts and the physical characteristics of the polyurethane products made therefrom, such as foam load-bearing, are not adversely affected and may even be improved by the reduction or elimination in the amount of conventional or reactive amine catalysts, and/or by reduction or elimination of organometallic catalysts.

The present invention is a process for the production of a polyurethane product by reaction of a mixture of
(a) at least one liquid organic polyisocyanate with
(b) at least one liquid polyol
(c) in the presence of at least one fusible catalyst, with a melting point between 35 and 130° C.;
(d) optionally in the presence of another polyurethane catalyst,
(e) optionally in the presence of a blowing agent; and
(f) optionally additives or auxiliary agents known per se for the production of polyurethane foams, elastomers and/or coatings.

In another embodiment, the present invention is a process whereby the fusible catalyst (c) is an amine based compound which is solid at room temperature, preferably a solid tertiary amine based polyol with autocatalytic characteristics.

In another embodiment, the present invention is a process whereby specific fusible catalysts (c) may have either blowing or gelling characteristics and are able to replace at least 10 percent of the conventional fugitive and/or reactive catalysts, more preferably 30 percent and most preferably at least 50 percent while keeping same processing conditions when making the polyurethane product.

In another embodiment, the present invention is a process as disclosed above wherein the polyisocyanate (a) contains at least one polyisocyanate that is a reaction product of a excess of polyisocyanate with the fusible catalyst.

In a further embodiment, the present invention is a process as disclosed above where the polyol (b) contains a polyol-terminated prepolymer obtained by the reaction of an excess of fusible catalyst with a polyisocyanate.

The invention further provides for polyurethane products produced by any of the above processes.

In accordance with the present invention, a process for the production of polyurethane products using reduced levels of conventional tertiary amine catalysts is disclosed. Such products are achieved by including in the polyol (b) as a dispersion either a fusible catalyst (c), which can contain a hydrogen reactive group, or by including such fusible catalyst (c) as an additional solid in the preparation of SAN, PIPA or PHD copolymer polyols (b2) and adding them to the polyol mixture (b) or by using fusible autocatalytic polyols (c) in a prepolymer with a polyisocyanate alone or with an isocyanate and a second polyol.

Fusible catalyst (c) once melted can be soluble in the polyurethane components, such as the polyol or the isocyanate. Preferably, it is not soluble in the polyol at room temperature.
Fusible catalysts (c) have the following advantages:
1) As the fusible catalysts are solid at room temperature, migration outside of the polyurethane product is reduced or eliminated. In addition, when the fusible catalyst contains reactive hydrogen group(s) able to react with isocyanate, the catalyst can be incorporated in the polyurethane polymer network.
2) They fusible catalysts act as catalysts at a late stage in the polyurethane reactions, that is once they have melted, and thus act as a delayed action catalyst.
3) As the catalysts are added as fine solid particles, they can act as reinforcers to increase polymer stiffness. This is especially prevalent if/when the fusible catalyst or its basic components have a crystalline structure.
4) The addition of fusible catalysts to polyurethane reaction mixtures can also reduce the mold dwell time in the production of molded foams or improve some polyurethane product properties, such as foam hardness.
5) The fusible catalyst may also act to stabilize large flexible foam buns which tend to sag and deform during the cooling/curing process.

The combination of polyols (b) with fusible catalysts (c) used in the present invention will be a combination of conventional polyols (b1), copolymer polyol (b2) and/or eventually of a polyol (b3) based on a tertiary amine, such as those made from an amine initiation as described in WO 01/58,976. As used herein the term polyols are those materials having at least one group containing an active hydrogen atom capable of undergoing reaction with an isocyanate. Preferred among such compounds are materials having at least two hydroxyls, primary or secondary, or at least two amines, primary or secondary, carboxylic acid, or thiol groups per molecule. Compounds having at least two hydroxyl groups or at least two amine groups per molecule are especially preferred due to their desirable reactivity with polyisocyanates.

Suitable polyols (b) that can be used to produce polyurethane materials with the fusible catalysts (c) of the present invention are well known in the art and include those described herein and any other commercially available polyol and/or SAN, PIPA or PHD copolymer polyols. Such polyols are described in “Polyurethane Handbook”, by G. Oertel, Hanser publishers. Mixtures of one or more polyols and/or one or more copolymer polyols may also be used to produce polyurethane products according to the present invention.

Representative polyols include polyether polyols, polyester polyols, polyhydroxy-terminated acetal resins, hydroxyl-terminated amines and polyamines. Examples of these and other suitable isocyanate-reactive materials are described more fully in U.S. Pat. No. 4,394,491. Alternative polyols that may be used include polyalkylene carbonate-based polyols and polyphosphate-based polyols. Preferred are polyols prepared by adding an alkylene oxide, such as ethylene oxide, propylene oxide, butylene oxide or a combination thereof, to an initiator having from 2 to 8, preferably 2 to 6 active hydrogen atoms. Catalysis for this polymerization can be either anionic or cationic, with catalysts such as KOH, CsOH, boron trifluoride, or a double cyanide complex (DMC) catalyst such as zinc hexacyanocobaltate or quaternary phosphazenium compound. In the case of alkaline catalysts, these alkaline catalysts are preferably eliminated from the polyol at the end of production by a proper finishing step, such as coalescence, magsil (magnesium silicate) separation or acid neutralization.

The polyol or blends thereof employed depends upon the end use of the polyurethane product to be produced. The molecular weight or hydroxyl number of the base polyol may thus be selected so as to result in flexible, semi-flexible, integral-skin or rigid foams, elastomers or coatings, or adhesives when the polymer/polyol produced from the base polyol is converted to a polyurethane product by reaction with an isocyanate, and depending on the end product in the presence of a blowing agent. The hydroxyl number and molecular weight of the polyol or polyols employed can vary accordingly over a wide range. In general, the hydroxyl number of the polyols employed may range from 15 to 800.

In the production of a flexible polyurethane foam, the polyol is preferably a polyether polyol and/or a polyester polyol. The polyol generally has an average functionality ranging from 2 to 5, preferably 2 to 4, and an average hydroxyl number ranging from 20 to 100 mg KOH/g, preferably from 20 to 70 mgKOH/g. As a further refinement, the specific foam application will likewise influence the choice of base polyol. As an example, for molded foam, the hydroxyl number of the base polyol may be on the order of 20 to 60 with ethylene oxide (EO) capping, and for slabstock foams the hydroxyl number may be on the order of 25 to 75 and is either mixed feed EO/PO (propylene oxide) or is only slightly capped with EO or is 100 percent PO based. For elastomer applications, it will generally be desirable to utilize relatively high molecular weight base polyols, from 2,000 to 8,000, having relatively low hydroxyl numbers, for example, 20 to 50.

Typically polyols suitable for preparing rigid polyurethanes include those having an average molecular weight of 100 to 10,000 and preferably 200 to 7,000. Such polyols also advantageously have a functionality of at least 2, preferably 3, and up to 8, preferably up to 6, active hydrogen atoms per molecule. The polyols used for rigid foams generally have a hydroxyl number of 200 to 1,200 and more preferably from 300 to 800.

For the production of semi-rigid foams, it is preferred to use a trifunctional polyol with a hydroxyl number of 30 to 80.

The initiators for the production of polyols (b) generally have 2 to 8 functional groups that will react with the alkylene oxide. Examples of suitable initiator molecules are water, organic dicarboxylic acids, such as succinic acid, adipic acid, phthalic acid and terephthalic acid and polyhydric, in particular dihydric to octahydric alcohols or dialkylene glycols, for example ethanediol, 1,2- and 1,3-propanediol, diethylene glycol, dipropylene glycol, 1,4-butanediol, 1,6-hexanediol, glycerol, trimethylolpropane, pentaerythritol, sorbitol and sucrose or blends thereof. Other initiators include compounds linear and cyclic amine compounds containing eventually a tertiary amine such as ethanoldiamine, triethanoldiamine, and various isomers of toluene diamine, ethylenediamine, N-methyl-1,2-ethanediamine, N-Methyl-1,3-propanediamine, N,N-dimethyl-1,3-diaminopropane, N,N-dimethylethanolamine, 3,3′-diamino-N-methyldipropylamine, aminopropyl-imidazole.

Amine based polyol (b3) can also contain a tertiary nitrogen in the chain, by using for instance an alkyl-aziridine as co-monomer with PO (propylene oxide) and EO (ethylene oxide), or (b3) can be capped with this tertiary amine, by using for example a N,N-dialkyl-glycidylamine.

Fusible catalysts are solid at room temperature and have a melting point between 35 and 130° C. Preferably the fusible catalysts have a melting point between 60 and 100° C. It has been found surprisingly that, when dispersed in the polyol in fine particles, they become, once melted due to heating or due to the exotherm of the polyurethane reactions, powerful catalysts. The fusible catalysts, once melted, accelerate the addition reaction of organic polyisocyanates with polyhydroxyl or polyamino compounds and the reaction between the isocyanate and the blowing agent such as water or a carboxylic acid or its salts.

Fusible catalysts can be made through various chemistries and preferably they are amine based. More preferably the fusible catalysts are the reaction product of an amine bearing reactive hydrogen with either an epoxide or with a lactone.

The solid epoxides for producing fusible catalysts are known in the art. See for example, EP 1,302,517. The epoxide materials can be monomeric or polymeric, saturated or unsaturated, aliphatic, cycloaliphatic, aromatic or heterocyclic and may be substituted if desired with other substituents besides the epoxy groups, for example, hydroxyl, ether radicals and aromatic halogen atoms. Preferred epoxides are aliphatic or cycloaliphatic polyepoxides, or glycidyl ether, more preferably diepoxides or triepoxides.

To obtain the solid fusible catalysts of the present invention, the starting epoxy resin is generally a solid at room temperature, the epoxy may be liquid at room temperatures that forms a solid catalyst after reaction with the amine. Particularly useful polyepoxide compounds which can be used in the practice of the present invention are epoxy resins which fit within the following general formulae:

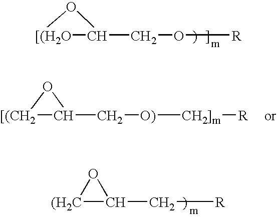

wherein R is substituted or unsubstituted aromatic, alphatic, cycloaliphatic or heterocyclic polyvalent group and m is an integer from 1 up to the valence of R. Preferably m does not exceed 3 and preferably m is 1 or 2. The ability to select an epoxy that is a solid within the above formula is known to those skilled in the art.

In general, a solid epoxy resin has an average equivalent weight of 90 to 2,500. More preferably the epoxy resin has an average equivalent weight of 150 to 1,500. Such epoxy resins generally have a molecular weight of less than 900. Preferably the epoxy resin has a molecular weight below 700. More preferably, the epoxy resin has a molecular weight below 600.

Examples of common epoxy resins include for example, the diglycidyl ethers of resorcinol, catechol, hydroquinone, bisphenol, bisphenol A, bisphenol AP (1,1-bis(4-hydroxylphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, trimethylolpropane triglycidyl ether, dicyclopentadiene-substituted phenol resins tetramethylbiphenol, tetramethyl-tetrabromobiphenol, tetramethyltribromobiphenol, tetrachlorobisphenol A and any combination thereof.

Examples of preferred epoxies include bisphenol A, bisphenol F and hydroquinone diglycidyl ether. A mixture of any two or more polyexpoxides can be used in the practice of the present invention.

Polyepoxides can be prepared by epoxidizing the corresponding allyl ethers or reacting a molar excess of epichlorohydrin and an aromatic polyhydroxy compound, such as novolak, isopropylidne bisphenol, resorcinol, etc. Polyepoxides can also be obtained by reacting an epihalohydrin with either a polyhydric phenol or a polyhydric alcohol.

Usually epoxide resins contain a relatively high amount of chlorine, both under the form of chloromethyl groups and as ionic chloride. Of particular interest for the present invention are low chlorine epoxy resins with less than 5 percent and more preferably less than 1 percent total chlorine.

As with the epoxy resins above, lactone or dilactone for use in the present invention are generally a solid at room temperature. Such lactones generally have 6 to 20 carbon atoms in the ring. Preferred are lactones having 6 to 18 carbon atoms in the ring. More preferred are lactones having 6 to 16 carbon atoms in the ring. Most preferred are lactones having 6 to 15 carbon atoms in the ring.

The carbons of the lactone ring may be substituted with an alkyl, cycloalkyl, alkoxy and single ring aromatic hydrocarbon radicals. When the carbon atoms of the ring contain such substituents, it is preferred that the total number of carbon atoms in the substituents on a lactone ring does not exceed about 12. Examples of suitable lactones include epsilon-caprolactone, methylcaprolactone, pentadecalactone, etc. Examples of suitable dilaciones are glycolide and lactide.

The amine compounds for producing the fusible catalysts (c) are those which react with an epoxide moiety or with a lactone to produce a tertiary amine based solid compound with a melting point between 35 and 130° C. Such compounds include secondary amines and/or molecules which contain a tertiary amine and at least one reactive hydrogen able to react with an epoxide or a lactone. Groups reactive with epoxides and lactones include primary or secondary, aliphatic or aromatic amines; primary, secondary and/or tertiary alcohols; amides; ureas; and urethanes. Based on the reaction between the amine and epoxy or lactone, the final fusible catalyst, in addition to being a solid at room temperature will contain a tertiary amine.

Generally, secondary amines can be represented by HN(R¹)₂ where each R¹ is independently a compound having 1 to 20 carbon atoms or may be attached together with the nitrogen atom and optionally other hetero atoms and alkyl-substituted hetero atoms to form a saturated or unsaturated heterocyclic ring.

Compounds containing at least one tertiary nitrogen and at least one hydrogen molecule reactive to an epoxide can be represented by (H)ₓ-A-R³-M-(R³)_{y} where A is nitrogen or oxygen; x is 1 when A is oxygen and 2 when A is nitrogen, R³ at each occurrence is independently a linear or branched alkyl having 1 to 20 carbon atoms; M is an amine or polyamine, linear or cyclic with at least one tertiary amine group; and y is an integer from 0 to 6; or (H)_{d}—N—(R³-M-(R³)_{y})_{b} where M, R³ and y are as previously defined, N is nitrogen, and b and d are either 1 or 2 such that the sum of b and d is 3; or

(R⁴)ₑ—Y—(R³-M)_{f}-(R³)_{y} or (R⁴)ₑ—Y—[(R³-M)-(R³)_{y}]_{f} where M, R³ and y are as previously defined;

R⁴ is hydrogen or a moiety having 1 to 20 carbon atoms, preferably R⁴ is an alkyl moiety;

Y is hydrogen, oxygen or nitrogen,

e is 0, 1 or 2;

f is 1 or 2;

with the provisos that e is zero when Y is hydrogen, e and f are 1 when Y is oxygen, and when Y is nitrogen, e and f can be 1 or 2 such that the sum of e and f is 3. Preferably M has a molecular weight of 30 to 300. More preferably M has a molecular weight of 50 to 200.

Examples of amines that are commercially available and that can be used to manufacture fusible catalysts (c) by reaction with an epoxide, dilactone or a lactone are methylamine, dimethylamine, diethylamine, N,N-dimethylethanolamine, N,N′-dimethylethylenediamine, N,N-dimethyl-N′-ethylenediamine, 3-dimethylamino-1-propanol, 1-dimethylamino-2-propanol, 3-(dimethylamino) propylamine, dicyclohexylamine, 4,6-dihydroxypyrimidine, 1-(3-aminopropyl)-imidazole, 3-hydroxymethyl quinuclidine, imidazole, 2-methyl imidazole, 1-(2-aminoethyl)-piperazine, 1-methyl-piperazine, 3-quinuclidinol, 2,4-diamino-6-hydroxypyrimidine, 2,4-diamino-6-methyl-1,3,5-triazine, 3-aminopyridine, 2,4-diaminopyrimidine, 2-phenyl-imino-3-(2-hydroxyethyl)-oxazalodine,N-(-2-hydroxyethyl)-2-methyl-tetrahydropyrimidine, N-(2-hydroxyethyl)-imidazoline,2,4-bis-(N-methyl-2-hydroxytethylamino)-6-phenyl-1,3,5-triazine, bis-(dimethylaminopropyl)amino-2-propanol, tetramethylamino-bis-propylamine, 2-(2-aminoethoxy)-ethanol, N,N-dimethylaminoethyl-N′-methyl ethanolamine, 2-(methylamino)-ethanol, 2-(2-methylaminoethyl)-pyridine, 2-(methylamino)-pyridine, 2-methylaminomethyl-1,3-dioxane, dimethylaminopropyl urea

Amines used in the present invention can also be polymers, such as amine capped polyols and/or polyamines. Fusible polymers (c) have preferably a MW below 3,000, more preferably below 2,000 and most preferably below 1,000. More preferably also these fusible catalysts (c) contain more than one tertiary amine group to maximize their catalytic effectiveness.

Fusible catalysts (c) are optionally epoxides reacted with an amine based compound as described above. When using a polyepoxide resin it is preferred to have at least 70 percent of these epoxide groups reacted with the amine, more preferably 90 percent and most preferably 100 percent. More than one amine or aminoalcohols can be reacted with the epoxide resin. Additionally other compounds can be used to help producing these amine epoxy adducts, that is catalysts, solvents etc.

The production of fusible catalyst (c) can be based on the reaction of an epoxide with at least one amine based molecule to obtain a tertiary amine function in the final molecule. The two reactants can be mixed together or the epoxide can first be pre-reacted partially. Addition of heat or cooling and proper catalysis may be used to control these reactions. It is important to note here that these epoxide-reactive hydrogen reactions are generating hydroxyl groups.

Alternatively, fusible catalyst (c) can be obtained by ring opening of a lactone or dilactone. The reaction of primary and secondary amines with cyclic esters forms amides bearing hydroxyl functionality. The amines of interest contain tertiary amine functionality as well as primary and secondary amine functionality, or hydroxyl functionality. Although the tertiary amine functionality does not directly form products with lactones or dilactones, it catalyzes oligomerization of the cyclic ester. Optionally the polyester can be further extended and/or functionalized with a diol, a triol or a quadrol.

The properties of the fusible catalyst (c) can vary widely. Preferably this fusible catalyst (c) has at least one reactive hydrogen and such parameters as average molecular weight, hydroxyl number, functionality, etc. will generally be selected based on the end use application of the formulation, that is, what type of polyurethane product.

The fusible catalyst (c) includes conditions where the polymer (c) is reacted with a polyisocyanate to form a prepolymer and subsequently a polyol is optionally added to such a prepolymer.

The limitations described with respect to the characteristics of the fusible catalyst (c) above are not intended to be restrictive but are merely illustrative of the large number of possible combinations.

In a preferred embodiment the epoxide of fusible catalyst (c) is a diepoxide and the amine based molecule containing at least one reactive hydrogen has a methyl-amino or a dimethyl amino or an amidine or a pyridine or a pyrimidine or a quinuclidine or an adamantane or a triazine or an imidazole or pyrrolidine ⁴structure combined with secondary and/or primary amines and/or secondary and/or primary hydroxyls.

In another preferred embodiment the lactone of fusible catalyst (c) is Epsilon-caprolactone and the amine based molecule containing at least one reactive hydrogen has a methyl-amino or a dimethyl amino or an amidine or a pyridine or a pyrimidine or a quinuclidine or an adamantane or a triazine or an imidazole or a pyrrolidine structure combined with secondary and/or primary amines and/or secondary and/or primary hydroxyls.

The molar ratio between the epoxy or the lactone and the amine is at least 1 and preferably 0.5. It is also possible that the epoxy or the lactone polymerize. In that case there is an excess of epoxy or lactone and the ratio is lower than 0.5.

The weight ratio of fusible catalyst (c) to polyol (b) will vary depending on the amount of additional catalyst one may desire to add to the reaction mix and to the reaction profile required by the specific application. Generally if a reaction mixture with a base level of catalyst having specified curing time, fusible catalyst (c) is added in an amount so that the curing time is equivalent where the reaction mix contains at least 10 percent by weight less conventional catalyst. Preferably the addition of (c) is added to give a reaction mixture containing 20 percent less catalyst than the base level. More preferably the addition of (c) will reduce the amount of catalyst required by 30 percent over the base level. For some applications, the most preferred level of (c) addition is where the need for a conventional, fugitive or reactive tertiary amine catalysts or organometallic salt is eliminated.

Combination of two or more fusible catalysts (c) of epoxy type or lactone type or combination therefrom can also be used with satisfactory results in a single polyurethane formulation when one wants for instance to adjust blowing and gelling reactions modifying for instance the amine structures with different tertiary amines, functionalities, equivalent weights, etc, and their respective amounts in the formulations.

Acid neutralization of fusible catalyst (c) can also be considered when for instance further delayed action is required. Acids used can be carboxylic acids such as formic or acetic acids, salicylic acid, chloroacetic acid, oxalic acid, acrylic acid, an amino acid or a non-organic acid such as sulfuric or phosphoric acid.

Polyols pre-reacted with polyisocyanates and fusible polymer catalyst (c3) with no free isocyanate functions can also be used in the polyurethane formulation. Isocyanate prepolymers based on fusible catalyst (c) can be prepared with standard equipment, using conventional methods, such a heating the polyol (c) in a reactor and adding slowly the isocyanate under stirring and then adding eventually a second polyol, or by prereacting a first polyol with a diisocyanate and then adding polymer (c).

Fusible catalyst (c) is either added as a fine powder to the polyurethane reactants or dispersed in the polyol (b) to which other additives are subsequently blended or is dispersed in the polyol premix together with water, surfactants and optionally other catalysts. Another alternative is to inject the fusible catalyst (c) in melted form directly in the foam formulation or in the mix-head of the foaming machine. Preferably the fusible catalyst (c) is dispersed in the polyol (b) by heating the catalyst above its melting point and by adding it to the polyol either hot or cold under stirring until the dispersion reaches a temperature below the melting point of the fusible catalyst (c).

The isocyanates which may be used with the autocatalytic polymers of the present invention include aliphatic, cycloaliphatic, arylaliphatic and aromatic isocyanates. Aromatic isocyanates, especially aromatic polyisocyanates are preferred.

Examples of suitable aromatic isocyanates include the 4,4′-, 2,4′ and 2,2′-isomers of diphenylmethane diisocyante (MDI), blends thereof and polymeric and monomeric MDI blends toluene-2,4- and 2,6-diisocyanates (TDI), m- and p-phenylenediisocyanate, chlorophenylene-2,4-diisocyanate, diphenylene-4,4′-diisocyanate, 4,4′-diisocyanate-3,3′-dimehtyldiphenyl, 3-methyldiphenyl-methane-4,4′-diisocyanate and diphenyletherdiisocyanate and 2,4,6-triisocyanatotoluene and 2,4,4′-triisocyanatodiphenylether.

Mixtures of isocyanates may be used, such as the commercially available mixtures of 2,4- and 2,6-isomers of toluene diisocyantes. A crude polyisocyanate may also be used in the practice of this invention, such as crude toluene diisocyanate obtained by the phosgenation of a mixture of toluene diamine or the crude diphenylmethane diisocyanate obtained by the phosgenation of crude methylene diphenylamine. TDI/MDI blends may also be used. MDI or TDI based prepolymers can also be used, made either with polyol (b1), polyol (b2) or any other polyol as described heretofore. Isocyanate-terminated prepolymers are prepared by reacting an excess of polyisocyanate with polyols, including aminated polyols or imines/enamines thereof, or polyamines.

Examples of aliphatic polyisocyanates include ethylene diisocyanate, 1,6-hexamethylene diisocyanate, isophorone diisocyanate, cyclohexane 1,4-diisocyanate, 4,4′-dicyclohexylmethane diisocyanate, saturated analogues of the above mentioned aromatic isocyanates and mixtures thereof.

The preferred polyisocyantes for the production of rigid or semi-rigid foams are polymethylene polyphenylene isocyanates, the 2,2′, 2,4′ and 4,4′ isomers of diphenylmethylene diisocyanate and mixtures thereof. For the production of flexible foams, the preferred polyisocyanates are the toluene-2,4- and 2,6-diisocyanates or MDI or combinations of TDI/MDI or prepolymers made therefrom.

Isocyanate tipped prepolymer based on polymer (b2) can also be used in the polyurethane formulation.

For rigid foam, the organic polyisocyanates and the isocyanate reactive compounds are reacted in such amounts that the isocyanate index, defined as the number or equivalents of NCO groups divided by the total number of isocyanate reactive hydrogen atom equivalents multiplied by 100, ranges from 80 to less than 500 preferably from 90 to 100 in the case of polyurethane foams, and from 100 to 300 in the case of combination polyurethane-polyisocyanurate foams. For flexible foams, this isocyanate index is generally between 50 and 120 and preferably between 75 and 110.

For elastomers, coating and adhesives the isocyanate index is generally between 80 and 125, preferably between 100 to 110.

For producing a polyurethane-based foam, a blowing agent is generally required. In the production of flexible polyurethane foams, water is preferred as a blowing agent. The amount of water is preferably in the range of from 0.5 to 10 parts by weight, more preferably from 2 to 7 parts by weight based on 100 parts by weight of the polyol. Carboxylic acids or salts are also used as reactive blowing agents. Other blowing agents can be liquid or gaseous carbon dioxide, methylene chloride, acetone, pentane, isopentane, methylol or dimethoxymethane, dimethylcarbonate. Use of artificially reduced atmospheric pressure can also be contemplated with the present invention.

In the production of rigid polyurethane foams, the blowing agent includes water, and mixtures of water with a hydrocarbon, or a fully or partially halogenated aliphatic hydrocarbon. The amount of water is preferably in the range of from 2 to 15 parts by weight, more preferably from 2 to 10 parts by weight based on 100 parts of the polyol. With excessive amount of water, the curing rate becomes lower, the blowing process range becomes narrower, the foam density becomes lower, or the moldability becomes worse. The amount of hydrocarbon, the hydrochlorofluorocarbon, or the hydrofluorocarbon to be combined with the water is suitably selected depending on the desired density of the foam, and is preferably not more than 40 parts by weight, more preferably not more than 30 parts by weight based on 100 parts by weight of the polyol. When water is present as an additional blowing agent, it is generally present in an amount from 0.5 to 10, preferably from 0.8 to 6 and more preferably from 1 to 4 and most preferably from 1 to 3 parts by total weight of the total polyol composition.

Hydrocarbon blowing agents are volatile C₁ to C₅ hydrocarbons. The use of hydrocarbons is known in the art as disclosed in EP 421 269 and EP 695 322. Preferred hydrocarbon blowing agents are butane and isomers thereof, pentane and isomers thereof (including cyclopentane), and combinations thereof.

Examples of fluorocarbons include methyl fluoride, perfluoromethane, ethyl fluoride, 1,1-difluoroethane, 1,1,1-trifluoroethane (HFC-143a), 1,1,1,2-tetrafluoroethane (HFC-134a), pentafluoroethane, difluoromethane, perfluoroethane, 2,2-difluoropropane, 1,1,1-trifluoropropane, perfluoropropane, dichloropropane, difluoropropane, perfluorobutane, perfluorocyclobutane, pentafluorobutane (HFC-365mfc), heptafluoropropane and pentafluoropropane.

Partially halogenated chlorocarbons and chlorofluorocarbons for use in this invention include methyl chloride, methylene chloride, ethyl chloride, 1,1,1-trichloroethane, 1,1-dichloro-1-fluoroethane (FCFC-141b), 1-chloro-1,1-difluoroethane (HCFC-142b), 1,1-dichloro-2,2,2-trifluoroethane (HCHC-123) and 1-chloro-1,2,2,2-tetrafluoroethane (HCFC-124).

Fully halogenated chlorofluorocarbons include trichloromonofluoromethane (CFC-11) dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. The halocarbon blowing agents may be used in conjunction with low-boiling hydrocarbons such as butane, pentane (including the isomers thereof), hexane, or cyclohexane or with water.

In addition to the foregoing critical components, it is often desirable to employ certain other ingredients in preparing polyurethane polymers. Among these additional ingredients are surfactants, preservatives, flame retardants, colorants, antioxidants, reinforcing agents, stabilizers and fillers.

In making polyurethane foam, it is generally preferred to employ an amount of a surfactant to stabilize the foaming reaction mixture until it cures. Such surfactants advantageously comprise a liquid or solid organosilicone surfactant. Other surfactants include polyethylene glycol ethers of long-chain alcohols, tertiary amine or alkanolamine salts of long-chain alkyl acid sulfate esters, alkyl sulfonic esters and alkyl arylsulfonic acids. Such surfactants are employed in amounts sufficient to stabilize the foaming reaction mixture against collapse and the formation of large, uneven cells. Typically, 0.2 to 3 parts of the surfactant per 100 parts by weight total polyol (b) are sufficient for this purpose.

One or more catalysts for the reaction of the polyol (and water, if present) with the polyisocyanate can be used. Any suitable urethane catalyst may be used, including tertiary amine compounds, amines with isocyanate reactive groups and organometallic compounds. Preferably the reaction is carried out in the absence of an amine or an organometallic catalyst or a reduced amount as described above. Exemplary tertiary amine compounds include triethylenediamine, N-methylmorpholine, N,N-dimethylcyclohexylamine, pentamethyldiethylenetriamine, tetramethylethylenediamine, bis (dimethylaminoethyl)ether, 1-methyl-4-dimethylaminoethyl-piperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylamino-propylamine and dimethylbenzylamine. Exemplary organometallic catalysts include organomercury, organolead, organoferric and organotin catalysts, with organotin catalysts being preferred among these. Suitable tin catalysts include stannous chloride, tin salts of carboxylic acids such as dibutyltin di-laurate, as well as other organometallic compounds such as are disclosed in U.S. Pat. No. 2,846,408. A catalyst for the trimerization of polyisocyanates, resulting in a polyisocyanurate, such as an alkali metal alkoxide may also optionally be employed herein. The amount of amine catalysts can vary from 0.02 to 5 percent in the formulation or organometallic catalysts from 0.001 to 1 percent in the formulation can be used.

A crosslinking agent or a chain extender may be added, if necessary. The crosslinking agent or the chain extender includes low-molecular polyhydric alcohols such as ethylene glycol, diethylene glycol, 1,4-butanediol, and glycerin; low-molecular amine polyol such as diethanolamine and triethanolamine; polyamines such as ethylene diamine, xlylenediamine, and methylene-bis(o-chloroaniline). The use of such crosslinking agents or chain extenders is known in the art as disclosed in U.S. Pat. Nos. 4,863,979 and 4,963,399 and EP 549,120.

When preparing rigid foams for use in construction, a flame retardant is generally included as an additive. Any known liquid or solid flame retardant can be used with the autocatalytic polyols of the present invention. Generally such flame retardant agents are halogen-substituted phosphates and inorganic flame proofing agents. Common halogen-substituted phosphates are tricresyl phosphate, tris(1,3-dichloropropyl phosphate, tris(2,3-dibromopropyl) phosphate and tetrakis (2-chloroethyl)ethylene diphosphate. Inorganic flame retardants include red phosphorous, aluminum oxide hydrate, antimony trioxide, ammonium sulfate, expandable graphite, urea or melamine cyanurate or mixtures of at least two flame retardants. In general, when present, flame retardants are added at a level of from 5 to 50 parts by weight, preferable from 5 to 25 parts by weight of the flame retardant per 100 parts per weight of the total polyol present.

The applications for foams produced by the present invention are those known in the industry. For example rigid foams are used in the construction industry and for insulation for appliances and refrigerators. Flexible foams and elastomers find use in applications such as furniture, shoe soles, automobile seats, sun visors, steering wheels, armrests, door panels, noise insulation parts and dashboards.

Processing for producing polyurethane products are well known in the art. In general components of the polyurethane-forming reaction mixture may be mixed together in any convenient manner, for example by using any of the mixing equipment described in the prior art for the purpose such as described in “Polyurethane Handbook”, by G. Oertel, Hanser publisher.

The polyurethane products are either produced continuously or discontinuously, by injection, pouring, spraying, casting, calendering, etc; these are made under free rise or molded conditions, with or without release agents, in-mold coating, or any inserts or skin put in the mold. In case of flexible foams, those can be mono- or dual-hardness.

For producing rigid foams, the known one-shot prepolymer or semi-prepolymer techniques may be used together with conventional mixing methods including impingement mixing. The rigid foam may also be produced in the form of slabstock, moldings, cavity filling, sprayed foam, frothed foam or laminates with other material such as paper, metal, plastics or wood-board. Flexible foams are either free rise and molded while microcellular elastomers are usually molded.

The following examples are given to illustrate the invention and should not be interpreted as limiting in anyway. Unless stated otherwise, all parts and percentages are given by weight.

A description of the raw materials used in the examples is as follows.
DEOA 85 percent is 85 percent pure diethanolamine and 15 percent water.
DMAPA is 3-dimethylamino-1-propylamine.
2-Methylimidazole is a tertiary amine with a reactive hydrogen available from Aldrich.
1-MP is 1-methylpiperazine available from Aldrich.
E-cap is Epsilon caprolactone or 6 -hexanolactone available from Aldrich.
HQDGDE is hydroquinone diglycidyl ether having an EEW (Epoxide equivalent weight) of 112.7.
Dabco DC 5169 is a silicone-based surfactant available from Air Products and Chemicals Inc.
TEGOSTAB B-8715LF is a silicone-based surfactant available from Goldschmidt.
Dabco 33 LV is a tertiary amine catalyst available from Air Products and Chemicals Inc.
Niax A-1 is a tertiary amine catalyst available from, Crompton Corporation.
Polyol A is a 1,700 equivalent weight propoxylated tetrol initiated with 3,3′-diamino-N-methyl dipropylamine and capped with 15 percent Ethylene oxide.
SPECFLEX NC 632 is a 1,700 EW polyoxypropylene polyoxyethylene polyol initiated with a blend of glycerol and sorbitol available from The Dow Chemical Company.
VORANOL CP 6001 is a 2,000 equivalent weight propoxylated triol initiated with glycerol and EO capped, available from The Dow Chemical Company
Voranol CP 1421 is a high EO containing triol, used as a cell opener available from The Dow Chemical Company.
SPECFLEX NC-700 is a 40 percent SAN based copolymer polyol with an average hydroxyl number of 20 available from The Dow Chemical Company.
VORANATE T-80 is TDI 80/20 isocyanate available from The Dow Chemical Company.
Specflex NE-150 is a MDI prepolymer available from The Dow Chemical Company.

All foams were made in the laboratory on the bench by preblending polyols, surfactants, crosslinkers, catalysts and water and then conditioned at 25° C. Isocyanate, also conditioned at 25° C., is added under stirring at 3,000 RPM for 5 seconds. At the end of mixing the reactants are poured in a 30×30×10 cm aluminum mold heated at 60° C. which is subsequently closed. The mold is sprayed with the release agent Klueber 41-2013, available from Klueber Chemie, prior to addition of the reactants. Foam curing at 4 minutes is assessed by manually demolding the part, looking for internal and external defects. If no defects, the part is rated as OK. Reactivity is measured from the mold exit time, that is the time when foaming mass begins to appear at the mold vent holes.

### EXAMPLE 1

### Preparation of Fusible Catalyst 1

Into a dry 1 liter resin kettle under nitrogen is loaded HQDGDE (90 grams, 0.7986 moles of epoxy) and 1-MP (83.98 grams, 0.8383 moles). A glass stir-shaft with fixed blades is inserted into kettle, the kettle is sealed and the apparatus is placed under positive nitrogen. A thermocouple is inserted into the kettle with a temperature controller, heating mantle, and overhead stir-motor completing the apparatus. Distilled N-methyl-pyrrolidone (200 mL) is injected into the kettle. The initial reaction set-point is 45° C. and a reaction exotherm to a maximum of about 88° C. is controlled with a water bath to cool the reaction vessel. After the exotherm subsides, the reaction set-point is 85° C. and reaction is kept at 85° C. overnight. Product is isolated by pouring the reaction mixture into 630 mL of acetone which is subsequently chilled with dry ice. The crystalline product obtained is collected by filtration under nitrogen. The crude product is dried at 60° C. in a vacuum oven with a yield of 127.5 grams. The product is recrystallized under a nitrogen pad from approximately 1200 mL of acetone and 10 mL of water and dried at 60° C. in a vacuum oven giving a yield of slightly more than 100 grams. The melting point peak maxima is 110° C. via DSC (Differential Scanning Calorimetry) at 10° C./min heating rate. From GC (Gas Chromatography) analysis, the residual 1-methylpiperazine is about 0.05 percent by weight.

### EXAMPLES 2 and 3

### Dispersion of Fusible Catalyst 1 in a Polyol

183 grams of Specflex NC-632 are heated to 120° C. in an oven together with 7.9 grams of the fusible catalyst of example 1. When the fusible catalyst is melted, both products are blended and allowed to cooled under stirring at 2,000 RPM. This results in formation of white dispersion.

For example 3, the same procedure is followed with 186 grams of Specflex NC-632 and 2.7 grams of fusible catalyst of example 1.

### EXAMPLE 4

### Preparation of a Fusible Polymer Catalyst

Into an oven dried 250 mL single neck round bottom flask equipped with a magnetic stir bar and air cooled condenser topped with gas inlet was loaded 16.8 (164 mmol) of DMAPA and 131.3 grams (1.15 moles) of E-cap. The reaction apparatus was evacuated (40 mm Hg) and then vented to nitrogen. The vacuum/nitrogen cycling was repeated 5 times ending on nitrogen. The flask was then submerged in an oil bath at 90° C. and the reaction mixture stirred at this temperature under a dynamic nitrogen atmosphere for 64 hours. The oil bath temperature was raised to 150° C. and the reaction mixture stirred at this temperature for 18 hours. The reaction mixture was then heated to an oil bath temperature of 180° C. for 8 hours and finally at 190° C. for 17 hours. The product was moderately viscous, clear, light yellow oil at elevated temperature but a cream colored solid at room temperature. The yield was 146.2 grams. Proton NMR analysis revealed that the product is an oligomeric polyester with a dimethylamino end group and with a degree of polymerization (n) of 5.84. The calculated number average molecular weight, Mn, of the material is approximately 883 g/mole and a measured melting point of between 55 and 60° C.

### EXAMPLES 5, 6, 7, 8

### Foam Production with Fusible Catalyst of Example 1

For examples 5 and 6, the fusible catalyst of example 1 is added as a fine powder to the polyol masterbatch and the mixture stirred at 2,000 RPM for 10 seconds prior to pouring in of the Voranate T-80. For examples 7 and 8, dispersions prepared as described in examples 2 and 3 were used. The polyol masterbatch includes the polyol and other additional components other than the fusible catalyst and isocyanate.

| | Example | | | | |
|---|---|---|---|---|---|
| | 5 | 6 | 7 | 8 | A* |
| Specflex | 70 | 70 | 70 | 70 | 70 |
| NC632 | | | | | |
| Specflex | 30 | 30 | 30 | 30 | 30 |
| NC 700 | | | | | |
| Catalyst | 3.0 | 5.0 | 3.0 | 1.0 | |
| example 1 | | | | | |
| Dispersion | | | Example 2 | Example 3 | |
| Niax A-1 | 0.05 | 0.05 | 0 | 0 | 0.05 |
| Dabco 33LV | 0.40 | 0.40 | 0.40 | 0.40 | 0.40 |
| DEOA 85 | 0.8 | 0.8 | 0.8 | 0.8 | 0.8 |
| percent | | | | | |
| Dabco DC | 0.6 | 0.6 | 0.6 | | 0.6 |
| 5169 | | | | | |
| Water | 3.5 | 3.5 | 3.5 | 3.5 | 3.5 |
| Voranate | 100 | 100 | 100 | 100 | 100 |
| T-80 | | | | | |
| Index | | | | | |
| Mold exit | 23 | 18 | 12 | 27 | 37 |
| time (s) | | | | | |
| Part | 343 | 341 | 325 | 311 | 339 |
| weight (g) | | | | | |
| Foam | OK | OK | OK | OK | OK |
| aspect | | | | | |

A* comparative example, not part of this invention

Foaming reactivity comparison (mold exit times) show that the catalyst is much more effective on a weight basis when it has been dispersed in the polyol prior to making the foam.

Examples 7 and 8 demonstrate that fusible catalyst is able to replace 100 percent of Niax A-1, a very powerful blowing catalyst.

### EXAMPLES 9, 10

### Foam Production with Fusible Polymer Catalyst of Example 4

The polymer catalyst of example 4 is heated at 120° C. and is added in liquid form in the polyol masterbatch, stirred at 3,000 RPM for 10 seconds, and then the Specflex NE-150 was added.

| | Example | | | | |
|---|---|---|---|---|---|
| | 9 | 10 | B* | C* | D* |
| Voranol CP | 98 | 94 | 98 | 98 | 98 |
| 6001 | | | | | |
| Voranol CP | 2 | 2 | 2 | 2 | 2 |
| 1421 | | | | | |
| Fusible | 4.5 | 6.0 | 0 | 0 | 0 |
| polymer | | | | | |
| example 4 | | | | | |
| Niax A-1 | 0.05 | 0.05 | 0.05 | 0.05 | 0.05 |
| Dabco 33LV | 0 | 0 | 0.40 | 0 | 0 |
| DMAPA | 0 | 0 | 0 | 0.6 | 0.8 |
| DEOA 85 | 0.6 | 0.6 | 0.6 | 0.6 | 0.6 |
| percent | | | | | |
| Tegostab | 0.5 | 0.5 | 0.5 | 0.5 | 0.5 |
| B8715LF | | | | | |
| Water | 3.7 | 3.7 | 3.7 | 3.7 | 3.7 |
| Specflex | 90 | 90 | 90 | 90 | 90 |
| NE-150 | | | | | |
| index | | | | | |
| Mold exit | 66 | 53 | 74 | 50 | 36 |
| time (s) | | | | | |
| Part | 413 | 408 | 410 | Collapse | 400 |
| weight (g) | | | | | |
| Part | Curing | OK | OK | | OK |
| aspect | limit | | | | |

Examples B*, C* and D* comparative examples, not part of the present invention.

Examples 9 and 10 show that fusible polymer catalyst of example 4 is able to replace 100 percent of Dabco 33 LV, a powerful gelling catalyst, and still produce good foam.

Comparison with examples C* and D* demonstrate that DMAPA reacted with E-Cap is a stronger catalyst than when used by itself as 4.5 PHP (parts weight per 100 parts weight polyol) fusible polymer catalyst of example 4 corresponds to 0.5 parts by weight of reacted DMAPA. In comparison B, the use of 0.6 PHP DMAPA as a straight amine caused foam collapse.

### EXAMPLE 11

A molded foam is made with the following formulation

| | |
|---|---|
| Polyol A | 30 |
| Specflex NC-632 | 40 |
| Specflex NC-700 | 30 |
| Fusible catalyst example 1 | 1.0 |
| Dabco 33 LV | 0.20 |
| Dabco DC-5169 | 0.60 |
| DEOA 85 percent | 0.80 |
| Water | 3.50 |
| Voranate T-80 index | 100 |

Mold exit time was 29 s. Demolding time was 4 minutes, foam density was 35.9

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

1. A process for the production of a polyurethane product by reaction of a mixture of
(a) at least one liquid organic polyisocyanate with
(b) at least one liquid polyol
(c) in the presence of at least one fusible catalyst, with a melting point between 35 and 130° C.
(d) optionally in the presence of another polyurethane catalyst,
(e) optionally in the presence of a blowing agent; and
(f) optionally additives or auxiliary agents known per se for the production of polyurethane foams, elastomers and/or coatings.

2. The process of claim 1 wherein the fusible catalyst is the reaction product of an amine having a reactive hydrogen with an epoxide, a lactone or with a dilactone.

3. The process of claim 2 wherein the epoxide is an aliphatic or cycloaliphatic polyepoxide or glycidyl ether.

4. The process of claim 3 wherein the polyepoxide is a diepoxide or triepoxide.

5. The process of claim 2 wherein the epoxide is represented by one of the formulae 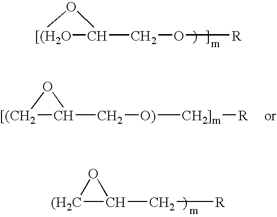
wherein R is substituted or unsubstituted aromatic, alphatic, cycloaliphatic or heterocyclic polyvalent group and n had an average value of from 1 to less than 8 and m is an integer from 1 up to the valence of R.

6. The process of claim 3 wherein the epoxy contains less than 5 percent by weight chlorine.

7. The process of claim 2 wherein the lactone has 6 to 20 carbon atoms in the ring.

8. The process of claim 7 wherein the lactone is selected from epsilon-caprolactone, methylcaprolactone, pentadecalactone, and the dilactone is selected from glycolide or lactide.

9. The process of claim 1 wherein the amine is represented by the formula HN(R¹)₂ where each R¹ is independently a compound having 1 to 20 carbon atoms or may be attached together with the nitrogen atom and optionally other hetero atoms and alkyl-substituted hetero atoms to form a saturated or unsaturated heterocyclic ring.

10. The process of claim 1 wherein the amine is represented by the formula (H)ₓ-A-R³-M-(R³)_{y} where A is nitrogen or oxygen; x is 2 when A is nitrogen and 1 when A is oxygen; R³ at each occurrence is independently a linear or branched alkyl having 1 to 20 carbon atoms; M is an amine or polyamine, linear or cyclic with at least one tertiary amine group; and y is an integer from 0 to 6.

11. The process of claim 1 wherein the amine is represented by the formula (H)_{d}—N—(R³-M-(R³)_{y})_{b} where N is nitrogen; R³ at each occurrence is independently a linear or branched alkyl having 1 to 20 carbon atoms; M is an amine or polyamine, linear or cyclic with at least one tertiary amine group; y is an integer from 0 to 6; and b and d are either 1 or 2 such that the sum of b and d is 3.

12. The process of claim 1 wherein the amine is represented by the formula (R⁴)ₑ—Y—(R³-M)_{f}(R³)_{y} or (R⁴)ₑ—Y—[(R³-M)-(R³)_{y}]_{f} where M is an amine or polyamine, linear or cyclic with at least one tertiary amine group;
R³ at each occurrence is independently a linear or branched alkyl having 1 to 20 carbon atoms;
R⁴ is hydrogen or a moiety having 1 to 20 carbon atoms, preferably R⁴ is an alkyl moiety;
Y is hydrogen, oxygen or nitrogen,
y is an integer from 0 to 6;
e is 0, 1 or 2;
f is 1 or 2;
with the provisos that e is zero when Y is hydrogen, e and f are 1 when Y is oxygen, and when Y is nitrogen, e and f can be 1 or 2 such that the sum of e and f is 3.

13. A polyurethane product produced by the process of claim 1.

14. A polyurethane catalyst comprising the reaction product of aminie having a reactive hydrogen with an epoxide wherein the epoxide is selected from one or more compounds of the formulae 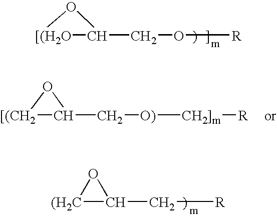
wherein R is substituted or unsubstituted aromatic, alphatic, cycloaliphatic or heterocyclic polyvalent group and n had an average value of from 1 to less than 8 and m is an integer from 1 up to the valence of R;
and the amine is selected from one or more compounds of the formulae HN(R¹)₂, wherein each R¹ is independently a compound having 1 to 20 carbon atoms or may be attached together with the nitrogen atom and optionally other hetero atoms and alkyl-substituted hetero atoms to form a saturated or unsaturated heterocyclic ring, (H)ₓ-A-R³-M-(R³)_{y} A is nitrogen or oxygen; x is 2 when A is nitrogen and 1 when A is oxygen; R³ at each occurrence is independently a linear or branched alkyl having 1 to 20 carbon atoms; M is an amine or polyamine, linear or cyclic with at least one tertiary amine group; and y is an integer from 0 to 6;
(H)_{d}—N—(R³-M-(R³)_{y})_{b} where R³, M and y are as defined above, N is nitrogen; b and d are either 1 or 2 such that the sum of b and d is 3;
(R⁴)ₑ—Y—(R³-M)_{f}(R³)_{y} or (R⁴)ₑ—Y—[(R³-M)-(R³)_{y}]_{f} where M, R³ and y are as defined above
R⁴ is hydrogen or a moiety having 1 to 20 carbon atoms, preferably R⁴ is an alkyl moiety;
Y is hydrogen, oxygen or nitrogen;
e is 0, 1 or 2;
f is 1 or 2;
with the provisos that e is zero when Y is hydrogen, e and f are 1 when Y is oxygen, and when Y is nitrogen, e and f can be 1 or 2 such that the sum of e and f is 3.

15. A polyurethane catalyst comprising the reaction product of amine having a reactive hydrogen with a lactone or dilactone wherein the lactone or dilactone has 6 to 20 carbon atoms in the ring and the amine is selected from one or more compounds of the formulae HN(R¹)₂ wherein each R¹ is independently a compound having 1 to 20 carbon atoms or may be attached together with the nitrogen atom and optionally other hetero atoms and alkyl-substituted hetero atoms to form a saturated or unsaturated heterocyclic ring,
(H)ₓ-A-R³-M-(R³)_{y} where A is nitrogen or oxygen; x is 2 when A is nitrogen and 1 when A is oxygen; R³ at each occurrence is independently a linear or branched alkyl having 1 to 20 carbon atoms; M is an amine or polyamine, linear or cyclic with at least one tertiary amine group; and y is an integer from 0 to 6;
(H)_{d}—N—(R³-M-(R³)_{y})_{b} where R³, M and y are as defined above, N is nitrogen; b and d are either 1 or 2 such that the sum of b and d is 3; or
(R⁴)ₑ—Y—(R³-M)_{f}(R³)_{y} or (R⁴)ₑ—Y—[(R³-M)-(R³)_{y}]_{f} where M, R³ and y are as defined above
R⁴ is hydrogen or a moiety having 1 to 20 carbon atoms, preferably R⁴ is an alkyl moiety;
Y is hydrogen, oxygen or nitrogen;
e is 0, 1 or 2;
f is 1 or 2;
with the provisos that e is zero when Y is hydrogen, e and f are 1 when Y is oxygen, and when Y is nitrogen, e and f can be 1 or 2 such that the sum of e and f is 3.

16. A polyisocyanate terminated polymer produced by the mixing of a molar excess of polyisocyanate with a catalyst of claim 14.

17. A polyol terminated prepolymer produced by the mixing of a molar excess of a catalyst of claim 14 with a polyisocyanate.

18. A polyisocyanate terminated polymer produced by the mixing of a molar excess of polyisocyanate with a catalyst of claim 15.

19. A polyol terminated prepolymer produced by the mixing of a molar excess of a catalyst of claim 15 with a polyisocyanate.
